(19) United States
(12) Patent Application Publication
(10) Pub. No.: US 2020/0263013 A1
(43) Pub. Date: Aug. 20, 2020

(54) COMPOSITIONS OBTAINED FROM RECYCLED POLYOLEFINS

(71) Applicant: BASELL POLIOLEFINE ITALIA S.R.L., MILANO (IT)

(72) Inventors: ROBERTO DE PALO, FERRARA (IT); CLAUDIO CAVALIERI, FERRARA (IT)

(73) Assignee: BASELL POLIOLEFINE ITALIA S.R.L., MILANO (IT)

(21) Appl. No.: 16/758,767

(22) PCT Filed: Nov. 5, 2018
(86) PCT No.: PCT/EP2018/080093

§ 371 Date: Apr. 23, 2020

(30) Foreign Application Priority Data
Nov. 13, 2017 (EP) 17201378.1

(51) Int. Cl. C08L 23/12; C08J 5/18; C08L 23/16; C08L 23/06

(52) U.S. Cl. CPC C08L 23/12; C08J 5/18; C08L 23/16; C08L 23/06; C08L 2207/20; C08J 2323/12; C08J 2323/06; C08L 2205/02; C08L 2207/02; C08J 2323/16

(57) ABSTRACT

A polyolefin composition made from or containing:
T1) 70-95 wt %, a polyolefin component containing:
a1) from 30 wt % to 70 wt % of a propylene based polymer; and
a2) from 30 wt % to 70 wt % of an ethylene based polymer; and
T2) 5-30 wt % of an heterophasic propylene ethylene copolymer.

### FIELD OF THE INVENTION

In general, the present disclosure relates to the field of chemistry. More specifically, the present disclosure relates to polymer chemistry. In particular, the present disclosure relates to compositions obtained from recycled polyolefins.

### BACKGROUND OF THE INVENTION

Polyolefins are consumed for many applications, including packaging for food and other goods, fibers, automotive components, and a variety of manufactured articles. However, the use of polyolefins is causing concern for environmental impact of the waste materials generated after the first use.

Waste plastic materials are coming from differential recovery of municipal plastic wastes, including flexible packaging (cast film, blown film and BOPP film), rigid packaging, blow-molded bottles and injection-molded containers. Through separation from other polymers, such as PVC, PET or PS, two main polyolefinic fractions of polyethylene and polypropylene are obtained.

A problem in polyolefin recycling is separating quantitatively polypropylene (PP) and polyethylene (PE). In some instances, commercial activities to recycle post-consumer waste (PCW) sources yield mixtures of PP and PE, wherein the minor component reaching up to <50 wt %.

In some instances, recycled PP/PE-blends suffer from deteriorated mechanical and optical properties, poor performance in odor and taste, and poor compatibility between the main polymer phases, resulting in limited impact strength and heat deflection resistance.

### SUMMARY OF THE INVENTION

In a general embodiment, the present disclosure provides a polyolefin compositions made from or containing:

T1) 70-95 wt %, a polyolefin component containing:

a1) from 30 wt % to 70 wt % of a propylene based polymer having a propylene content higher than 60 wt %; and

a2) from 30 wt % to 70 wt % of an ethylene based polymer having an ethylene content higher than 70;

the sum of a1) and a2), being referred to the total weight of a1) and a2), being 100; and

T2) 5-30 wt % of an heterophasic propylene ethylene copolymer having:
i) a content of ethylene derived units ranging from 6.0 wt % to 16.0 wt %;
ii) a fraction soluble in xylene at 25° C. (XS) ranging from 15 wt % to 45 wt %;
iii) an intrinsic viscosity (η) of the fraction soluble in xylene at 25° C. ranging from 4.0 to 9.0 dl/g; and
iv) a melt flow rate, measured according to ISO 1133 at 230° C. with a load of 2.16 kg, ranging from 0.3 to 50.0 g/10 min;

the sum of the amount of T1)+T2), being referred to the total weight of T1) and T2), being 100.

### DETAILED DESCRIPTION OF THE INVENTION

In some embodiments, the present disclosure provides a polyolefin compositions made from or containing:

T1) 70-95 wt %, alternatively 75-90 wt %; alternatively from 77 wt % to 85 wt %, of a polyolefin component containing:

a1) from 30 wt % to 70 wt %, alternatively from 40 wt % to 60 wt %, alternatively from 45 wt % to 55 wt %, of a propylene based polymer having a propylene content higher than 60 wt %: alternatively higher than 70 wt %; alternatively higher than 80 wt %, alternatively higher than 90 wt %; and

a2) from 30 wt % to 70 wt %, alternatively from 40 wt % to 60 wt %, alternatively from 45 wt % to 55 wt %, of an ethylene based polymer having an ethylene content higher than 70, alternatively higher than 75 wt %; alternatively higher than 80 wt %, alternatively higher than 90 wt %;

the sum of a1) and a2), being referred to the total weight of a1) and a2), being 100; and

T2) 5-30 wt %, alternatively 10-25 wt %; alternatively from 15 wt % to 23 wt %, of an heterophasic propylene ethylene copolymer having:
i) a content of ethylene derived units ranging from 6.0 wt % to 16.0 wt %, alternatively from 8.0 wt % to 14.0 wt %; alternatively from 9.0 wt % to 12.0 wt %;
ii) a fraction soluble in xylene at 25° C. (XS) ranging from 15 wt % to 45 wt %; alternatively from 20 wt % to 40 wt %; alternatively from 30 wt % to 35 wt %;
iii) an intrinsic viscosity (η) of the fraction soluble in xylene at 25° C. ranging from 4.0 to 9.0 dl/g; alternatively from 5.0 to 8.3 dl/g; alternatively from 5.6 to 7.9 dl/g; and
iv) a melt flow rate, measured according to ISO 1133 at 230° C. with a load of 2.16 kg, ranging from 0.3 to 50.0 g/10 min; alternatively from 0.4 to 20.0 g/10 min; alternatively from 0.5 to 4.0 g/10 min.

the sum of the amount of T1) and T2), being referred to the total weight of T1) and T2), being 100. In some embodiments, the polyolefin composition has a melt flow rate (230° C./2.16 kg) between 0.5 to 25 g/10 min.

The heterophasic propylene ethylene copolymer is a polymer made from or containing a matrix made from or containing an isotactic propylene homopolymer and a rubber phase dispersed in the matrix being a propylene ethylene copolymer.

In some embodiments, the polyolefin composition is used for the production of films, including cast films, blown films, bioriented films, monolayer films or multilayer films with a reduction of gels number in the films.

In some embodiments, component T1) is a mixture of recycled polypropylene and polyethylene blend.

In some embodiments, component a1) is propylene homopolymer containing from 0 to 5 wt % of comonomers being olefin derived units, alternatively alpha olefins derived units having from 2 to 10 carbon atoms. In some embodiments, the alpha-olefin derived units having from 2 to 10 carbon atoms are selected from the group consisting of ethylene, 1-butene, 1-hexene and 1-octene derived units. In some embodiments, the alpha-olefin derived units are ethylene derived units. In some embodiments, component a1) is propylene homopolymer.

In some embodiments, component a2) is an ethylene homopolymer or copolymer containing from 0 to 20 wt % of comonomers being olefin derived units, alternatively alpha olefins derived units having from 3 to 10 carbon atoms. In some embodiments, the alpha olefins derived units having from 3 to 10 carbon atoms are selected from the group consisting of propylene, 1-butene, 1-hexene and 1-octene derived units. In some embodiments, the alpha olefins derived units having from 3 to 10 carbon atoms are selected from the group consisting of 1-butene and 1-hexene derived units.

In some embodiments, propylene ethylene copolymers commercially available from LyondellBasell are used as T2). In some embodiments, the commercial propylene ethylene copolymer bears product number Hifax X1956A.

The following examples are given in order to illustrate, but not limit the present disclosure.

### EXAMPLES

### Characterizations

Xylene-Soluble (XS) Fraction at 25° C.

Solubility in xylene: Determined as follows:

2.5 g of polymer and 250 ml of xylene were introduced in a glass flask equipped with a refrigerator and a magnetic stirrer. The temperature was raised in 30 minutes up to the boiling point of the solvent. The resulting clear solution was then kept under reflux and stirred for 30 minutes. The closed flask was then kept for 30 minutes in a bath of ice and water, then in a thermostatic water bath at 25° C. for 30 minutes. The resulting solid was filtered on quick filtering paper. 100 ml of the filtered liquid was poured in a pre-weighed aluminum container, which was heated on a heating plate under nitrogen flow to remove the solvent by evaporation. The container was then kept in an oven at 80° C. under vacuum until a constant weight was obtained. The weight percentage of polymer soluble in xylene at room temperature was then calculated.

The content of the xylene-soluble fraction is expressed as a percentage of the original 2.5 grams and then, by the difference (complementary to 100%), the xylene insoluble percentage (%).

Melt Flow Rate (MFR)

Measured according to ISO 1133 at 230° C. with a load of 2.16 kg.

Intrinsic Viscosity (IV)

The sample was dissolved in tetrahydronaphthalene at 135° C. and then poured into a capillary viscometer. The viscometer tube (Ubbelohde type) was surrounded by a cylindrical glass jacket, which permitted temperature control with a circulating thermostatic liquid. The downward passage of the meniscus was timed by a photoelectric device.

The passage of the meniscus in front of the upper lamp started the counter which had a quartz crystal oscillator. The counter stopped as the meniscus passed the lower lamp and the efflux time was registered. The efflux time was converted into a value of intrinsic viscosity through Huggins' equation (Huggins, M. L., J. Am. Chem. Soc., 1942, 64, 2716), based upon the flow time of the solvent at the same experimental conditions (same viscometer and same temperature). A single polymer solution was used to determine [η].

Ethylene Content in the Copolymers

¹³C NMR spectra were acquired on a Bruker AV-600 spectrometer equipped with cryoprobe, operating at 160.91 MHz in Fourier transform mode at 120° C.

The peak of the S_{ββ} carbon (nomenclature according to “Monomer Sequence Distribution in Ethylene-Propylene Rubber Measured by ¹³C NMR. 3. Use of Reaction Probability Mode,” C. J. Carman, R. A. Harrington and C. E. Wilkes, Macromolecules 10, 536 (1977)) was used as an internal reference at 29.9 ppm. The samples were dissolved in 1,1,2,2-tetrachloroethane-d2 at 120° C. with an 8% wt/v concentration. Each spectrum was acquired with a 90° pulse, 15 seconds of delay between pulses and composite pulse decoupling (CPD) to remove ¹H-¹³C coupling. 512 transients were stored in 32K data points using a spectral window of 9000 Hz.

The assignments of the spectra, the evaluation of the triad distribution and the composition were made according to Kakugo (“Carbon-13 NMR Determination of Monomer Sequence Distribution in Ethylene-Propylene Copolymers Prepared with δ-Titanium Trichloride-Diethylaluminum Chloride,” M. Kakugo, Y. Naito, K. Mizunuma and T. Miyatake, Macromolecules 15, 1150(1982)) using the following equations:

| | | |
|---|---|---|
| PPP = 100 T_{ββ}/S | PPE = 100 T_{βδ}/S | EPE = 100 T_{δδ}/S |
| PEP = 100 S_{ββ}/S | PEE = 100 S_{βδ}/S | EEE = 100 (0.25 S_{γδ} + 0.5 S_{δδ})/S |

S = T_{ββ} + T_{βδ} + T_{δδ} + S_{ββ} + S_{βδ} + 0.25 S_{γδ} + 0.5 S_{δδ}

The molar percentage of ethylene content was determined using the following equation:

E % mol=100*[PEP+PEE+EEE]. Additionally, the weight percentage of ethylene content was determined using the following equation:

$$E \% wt . = \frac{100 * E \% mol * M {W}_{E}}{E \% mol * M {W}_{E} + P \% mol * M {W}_{P}}$$

wherein P % mol is the molar percentage of propylene content while MW_{E} and MW_{P} are the molecular weights of ethylene and propylene, respectively.

The product of reactivity ratio r₁r₂ was calculated according to Carman (C. J. Carman, R. A. Harrington and C. E. Wilkes, Macromolecules 10, 536 (1977)) as:

$${r}_{1} {r}_{2} = 1 + ( \frac{E E E + P E E}{P E P} + 1 ) - ( \frac{P}{E} + 1 ) {( \frac{E E E + P E E}{P E P} + 1 )}^{0.5}$$

The tacticity of propylene sequences was calculated as mm content from the ratio of the PPP mmT_{ββ} (28.90-29.65 ppm) and the whole T_{ββ} (29.80-28.37 ppm)

Production of T1 Component

To simulate waste recycled polyolefin composition, a blend of 50 wt % of Hostalen GF 9055 F high density polyethylene, which was commercially available from LyondellBasell, and 50 wt % of Moplen HP561R polypropylene homopolymer, which was commercially available from LyondellBasell, was prepared.

T1 component was blended with various propylene based copolymers. A cast film was obtained with the resulting composition. The compositions and the gel number of the film are reported in Table 1.

TABLE 1

| Ex | | Comp 1 | Ex 2 | Comp 3 |
|---|---|---|---|---|
| T1 | Wt % | 100 | 80 | 80 |
| T2 | | | | |
| Hifax | Wt % | 0 | 20 | |
| x1956A | | | | |
| Adflex X500F | Wt % | 0 | | 20 |
| Gel | 1/m² | 728 | 77 | 851 |
| number <200 mu | | | | |

Adflex X500F heterophasic composition is commercially available from LyondellBasell. Adflex X500F has an ethylene content of about 57 wt % and a fraction soluble in xylene at 25° C. of 25 wt %. The intrinsic viscosity of the fraction soluble in xylene at 25° C. is 1.34 dl/g, and the MFR is about 7 g/10 min.

Hifax X 1956 A heterophasic TPO (thermoplastic polyolefin) polypropylene is commercially available from LyondellBasell. Hifax X 1956 has an ethylene content of 11.0 wt % and a fraction soluble in xylene at 25° C. of 29 wt %. The intrinsic viscosity of the fraction soluble in xylene at 25° C. is 6.8 dl/g, and the MFR is 1.7 g/10 min.

The gels count test was carried out on a cast film Collin Extrusion line diameter with a 25 mm single screw with the following features:

Single screw L/D 25

Temperature profile

Cylinders 200 (close to the hopper)->230° C. (at the end of the extruder, before the inlet to the die)

Die 240° C.

Die width 150 mm

Chill roll 30° C.

Film speed 3.0 m/min

Film thickness 50 micron

Inspected area 1 m2

OCS FS5 gel count unit on a 4 cm wide stripe

The elongation at break of cast films of example 2 and comparative examples 1 and 3 have been measured in machine direction (MD) and transverse direction (TD) according ASTM D 882 in Table 2.

TABLE 2

| | Elongation at break MD % | Elongation at break TD % |
|---|---|---|
| Comp ex 1 | 1110 | 7 |
| Ex 2 | 1160 | 1020 |
| Comp ex 3 | 1190 | 7 |

What is claimed is:

1. A polyolefin composition comprising:
T1) 70-95 wt %, a polyolefin component containing:
a1) from 30 wt % to 70 wt % of a propylene based polymer having a propylene content higher than 60 wt %; and
a2) from 30 wt % to 70 wt % of an ethylene based polymer having an ethylene content higher than 70;
the sum of a1) and a2), being referred to the total weight of a1) and a2), being 100; and
T2) 5-30 wt % of an heterophasic propylene ethylene copolymer having:
i) a content of ethylene derived units ranging from 6.0 wt % to 16.0 wt %;
ii) a fraction soluble in xylene at 25° C. (XS) ranging from 15 wt % to 45 wt %;
iii) an intrinsic viscosity (η) of the fraction soluble in xylene at 25° C. ranging from 4.0 to 9.0 dl/g; and
iv) a melt flow rate, measured according to ISO 1133 at 230° C. with a load of 2.16 kg, ranging from 0.3 to 50.0 g/10 min;
the sum of the amount of T1) and T2), being referred to the total weight of T1) and T2), being 100.

2. The polyolefin composition according to claim 1, wherein component T2 contains from 8.0 wt % to 14.0 wt % of ethylene derived units.

3. The polyolefin composition according to claim 1, wherein component T2 contains from 9.0 wt % to 12.0 wt % of ethylene derived units.

4. The polyolefin composition according to claim 1, wherein component T2 has a melt flow rate ranging from 0.4 to 20.0 g/10 min.

5. The polyolefin composition according to claim 1, wherein component T2 has a melt flow rate ranging from 0.5 to 4.0 g/10 min.

6. The polyolefin composition according to claim 1, wherein component T2 has the intrinsic viscosity (η) of the fraction soluble in xylene at 25° C. ranging from 5.0 to 8.3 dl/g.

7. The polyolefin composition according to claim 1, wherein component T2 has the intrinsic viscosity (η) of the fraction soluble in xylene at 25° C. ranging from 5.6 to 7.9 dl/g.

8. The polyolefin composition according to claim 1, wherein component T2 has the fraction soluble in xylene at 25° C. (XS) ranging from 20 wt % to 40 wt %.

9. The polyolefin composition according to claim 1, wherein the polyolefin composition has a melt flow rate (230° C./2.16 kg) between 0.5 to 25 g/10 min.

10. The polyolefin composition according to claim 1, wherein component a1) ranges from 45 wt % to 55 wt % and component a2) from 45 wt % to 55 wt %.

11. The polyolefin composition according to claim 1, wherein component T1) is a mixture of recycled polypropylene and polyethylene blend.

12. The polyolefin composition according to claim 1, wherein component a1) is propylene homopolymer containing from 0 to 5 wt % of comonomers being olefin derived units.

13. The polyolefin composition according to claim 1, wherein a2) is an ethylene homopolymer or copolymer containing from 0 to 20 wt % of comonomers being olefin derived units.

14. A film comprising the polyolefin compositions of claim 1.

15. The film according to claim 14 being a cast film, a blown film, a bioriented film, a monolayer film, or a multilayer film.
